(19) United States
(12) Patent Application Publication
(10) Pub. No.: US 2026/0105827 A1
(43) Pub. Date: Apr. 16, 2026

(54) METHOD FOR STANDALONE DEVICE WIRELESSLY COMMUNICATING WITH RECIPIENT DEVICE, AND WIRELESS COMMUNICATION SYSTEM INCLUDING THE SAME

(71) Applicant: Wingcherk LEE, Tory, MI (US)

(72) Inventor: Wingcherk LEE, Tory, MI (US)

(73) Assignee: Jeremy Kowk-Kuen Hon, Taipei City (TW)

(21) Appl. No.: 18/917,337

(22) Filed: Oct. 16, 2024

(51) Int. Cl. G08B 21/04; G08B 5/38; G08B 21/24

(52) U.S. Cl. CPC G08B 21/04; G08B 5/38; G08B 21/24

(57) ABSTRACT

In an aspect of the disclosure, a method for a standalone device wirelessly communicating with a recipient device is provided. The method comprises setting, by an administrator, a wake-up alarm of the standalone device with a first preset time, a wellness check notification from the recipient device. The method also comprises triggering the wake-up alarm of the standalone device by the first preset time, wherein the wake-up alarm enables to flash an indication light of a first button of the standalone device. The method also comprises informing, by the standalone device, the recipient device if the wake-up alarm of the standalone device is not canceled by pressing the first button by a user within a second preset time. All communications between the standalone device user and recipient device user do not require any monitoring service.

### TECHNICAL FIELD

The disclosure relates in general to a method for a standalone device wirelessly communicating with a recipient device, and more particularly, to a system including the standalone device wirelessly coupled to the recipient device, with automatic notification between the standalone device and the recipient device in case some events occur. The communication between the standalone device user and the recipient device user does not require any monitoring service.

### BACKGROUND

Since many seniors (or elderly) live alone (or standalone), for example, it is estimated that there are 14 million seniors (or elderly) living alone in the US, in the event of the senior passing away during sleep or becoming incapacitated, there is no way that the person (senior or the elderly) can inform anyone. It might take a period (maybe days or even weeks) before someone discovers the person has deceased. There are some devices for seniors or elderly to press a button to inform the monitoring service for help. However, when the person (senior or the elderly) loses consciousness, he/she would not be able to press the button for help.

### SUMMARY

The present disclosure describes techniques to remedy the foresaid problem, which provide a method for a standalone device wirelessly communicating with a recipient device, and a system including the same. The standalone device and system are designed for simple to use with minimal user interaction.

The first aspect of the present disclosure features a method for a standalone device wirelessly communicating with a recipient device. The method comprises setting, by an administrator, a wake-up alarm of the standalone device with a first preset time. The method also comprises triggering the wake-up alarm of the standalone device by the first preset time, wherein the wake-up alarm enables to flash an indication light of a first button (for cancel or confirmation) of the standalone device. The method also comprises informing, by the standalone device, the recipient device if the alarm of the standalone device is not canceled by pressing the first button by a device user within a second preset time.

In some implementations according to the first aspect of the present disclosure, the method further comprises sending a diagnostic signal, by the recipient device, automatically, to the standalone device with an interval of a third preset time. The method also comprises generating an alert message on the recipient device, upon determining that the standalone device fails to respond to the diagnostic signal.

The second aspect of the present disclosure features a wireless communication system. The system comprises a standalone device comprising an alarm and a first button including an indication light. The system also comprises a recipient device, wirelessly coupled to the standalone device. By the first preset time of a wake-up alarm set by an administrator, the alarm of the standalone device is triggered to flash the indication light of the first button of the standalone device and to sound, and the standalone device informs the recipient device if the alarm of the standalone device is not canceled by pressing the first button by a device user within a second preset time.

In some implementations according to the second aspect of the present disclosure, the recipient device automatically sends a diagnostic signal to the standalone device with an interval of a third preset time, and the recipient device generates an alert message upon determining that the standalone device fails to respond to the diagnostic signal.

In some implementations according to the first aspect or the second aspect of the present disclosure, upon determining that the wake-up alarm of the standalone device is not canceled within the second preset time, the standalone device sends a notification to the recipient device.

In some implementations according to the first aspect or the second aspect of the present disclosure, upon determining that the standalone device receives a wellness check notification from the recipient device, the alarm of the standalone device is triggered to flash the indication light of the first button of the standalone device, and the standalone device informs the recipient device whether the alarm of the standalone device is canceled by pressing the first button by a device user within the second preset time.

In some implementations according to the first aspect or the second aspect of the present disclosure, the first preset time of the wake-up alarm of the standalone device is adjustable by the administrator via the recipient device.

In some implementations according to the first aspect or the second aspect of the present disclosure, by the interval of a fourth preset time of a wellness check or medicine reminder alarm set by the administrator, the alarm of the standalone device is triggered to flash the indication light of the first button of the standalone device, and the standalone device informs the recipient device if the alarm of the standalone device is not canceled by pressing the first button by the device user within the second preset time. The wellness check feature on standalone is the same as initiated from recipient device as described in [0009]. The interval of fourth preset time is not affected by wellness check notification sent from the recipient device.

In some implementations according to the first aspect or the second aspect of the present disclosure, a next alarm due to the first preset time or the interval of the fourth preset time is skippable by pressing the first button to flash the indication light without the wake-up alarm or the wellness check/medicine reminder alarm, and pressing the first button again while the indication light flashing, by the device user.

The third aspect of the present disclosure features a standalone device. The standalone device comprises a wireless communication module, an alarm clock module, a first button, including an indication light, and a second button, used for emergence notification (SOS). By a first preset time of a wake-up alarm set by an administrator, the alarm of the standalone device is triggered to flash the indication light of the first button of the standalone device, and the standalone device informs a wirelessly coupled recipient device via the wireless communication module if the alarm of the standalone device is not canceled by pressing the first button by a device user within a second preset time.

In some implementations according to the third aspect of the present disclosure, wherein upon determining that the wake-up alarm of the standalone device is not canceled within the second preset time, the standalone device sends a notification to the recipient device via the wireless communication module from the wirelessly coupled recipient device.

In some implementations according to the third aspect of the present disclosure, the standalone device receives a diagnostic signal automatically sent by the wirelessly coupled recipient device with an interval of a third preset time, and the wirelessly coupled recipient device receives an alert message upon determining that the standalone device fails to respond to the diagnostic signal.

In some implementations according to the third aspect of the present disclosure, upon determining that the standalone device receives a wellness check notification from the recipient device, the alarm of the standalone device is triggered to flash the indication light of the first button of the standalone device, and the standalone device informs the wirelessly coupled recipient device via the wireless communication module whether the alarm of the standalone device is canceled by pressing the first button by the device user within the second preset time.

In some implementations according to the third aspect of the present disclosure, the first preset time of the wake-up alarm of the standalone device is adjustable by the administrator via the wireless coupled recipient device.

In some implementations according to the third aspect of the present disclosure, a next alarm due to the first preset time is skippable by pressing the first button to flash the indication light without the wake-up alarm, and pressing the first button again while the indication light flashing, by the device user.

In some implementations according to the third aspect of the present disclosure, the standalone device further comprises a second button configured to send emergence signal. When the second button is pressed by the user for emergency, the alarm of the standalone device is triggered to flash the indication light of the first button of the standalone device. The standalone device informs the wirelessly coupled recipient device via the wireless communication module upon determining that the alarm of the standalone device is not canceled by pressing the first button by the user within a second preset time. The standalone device is reset and returned to a standby state upon determining that the alarm of the standalone device is canceled by pressing the first button by the user within the second preset time.

In some implementations according to the first, second or third aspect of the present disclosure, no monitoring service is required for all communications between the standalone device user and recipient device user.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a block diagram illustrating an example wireless communication system, according to some implementations of the present disclosure.

FIG. 2A is a diagram illustrating the front view of an example standalone device in alarm clock form, according to some implementations of the present disclosure.

FIG. 2B is a diagram illustrating the rear view of an example standalone device in alarm clock form, according to some implementations of the present disclosure.

FIG. 3A is a diagram illustrating the front view of an example standalone device in pendant form, according to some implementations of the present disclosure.

FIG. 3B is a diagram illustrating the rear view of an example standalone device in pendant form, according to some implementations of the present disclosure.

FIG. 4A is a diagram illustrating the front view of an example standalone device in digit watch form, according to some implementations of the present disclosure.

FIG. 4B is a diagram illustrating the rear view of an example standalone device in digit watch form, according to some implementations of the present disclosure.

FIG. 5 is a diagram illustrating the App functions of an example device, according to some implementations of the present disclosure.

FIG. 6 is a flow chart of an example method (Disable Alarm process) for a standalone device wirelessly communicating with a recipient device, according to some implementations of the present disclosure.

FIG. 7 is a flow chart of another example method (Wellness Check Notification process) for a standalone device wirelessly communicating with a recipient device, according to some implementations of the present disclosure.

FIG. 8 is a flow chart of yet another example method (Automatic Diagnostic process) for a standalone device wirelessly communicating with a recipient device, according to some implementations of the present disclosure.

FIG. 9 is a flow chart of an example method (Skip Next Alarm process) for a standalone device skipping the next alarm, according to some implementations of the present disclosure.

FIG. 10 is a flow chart of an example method (Emergency Notification) for a standalone device for sending emergence (SOS) signal, according to some implementations of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms “comprise,” “comprising,” “include,” “including,” “has,” “having,” etc. used in this specification are open-ended and mean “comprises but not limited.” The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

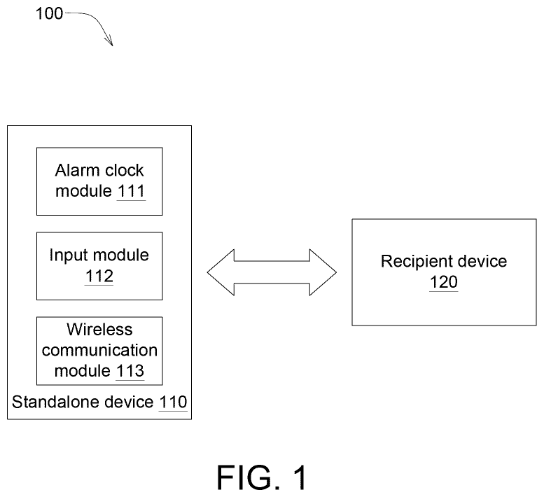

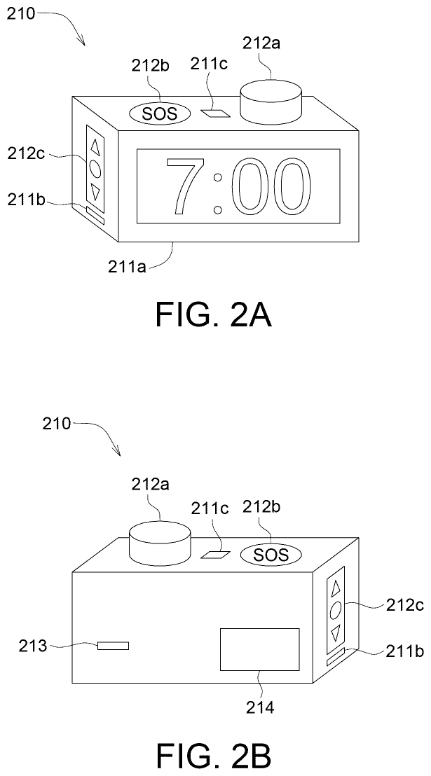

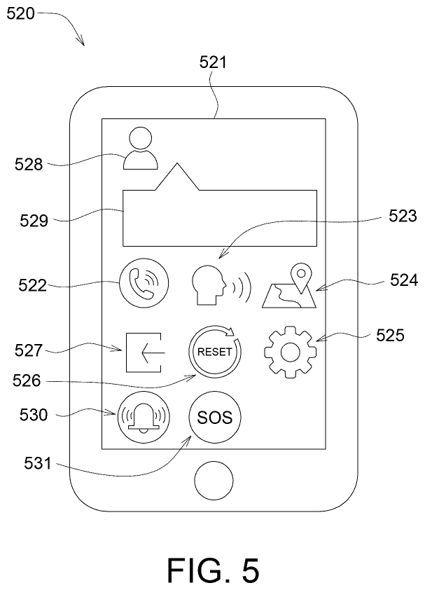

FIG. 1 is block diagram illustrating an example wireless communication system 100, according to some implementations of the present disclosure. In FIG. 1, the wireless communication system 100 comprises a standalone device 110 and a recipient device 120. In some implementations, the standalone device 110 includes an alarm clock module 111, an input module 112 and a wireless communication module 113. In some implementations, the alarm clock module 111 may be periodically set for wake-up alarms or wellness check /arm/ medicine reminder alarms at certain times of the day or with an interval of various preset time. In some implementations, the standalone device 110 can be configured to perform wellness check alarm or medicine reminder alarm as optional feature, which can be added and deleted at any time. In some implementations, the standalone device 110 performs only the wake-up alarm, which is adjustable and cannot be deleted, wherein the time of the wake-up alarm reset every day after the device user cancels the wake-up alarm. In some implementations, the alarm clock module 111 may include a display of clock and a speaker for alarming a device user, who might be a senior or elderly. In some implementations, the input module 112 may include multiple buttons. In this case, one of the buttons including an indication light, is configured for informing the device user to press the button to respond to various functions of the wireless communication system 100, which those functions will be described referring to as follows. In some implementations, another button of the buttons is used as an emergency or SOS button, which sends a notification to notify the recipient(s) (designated individuals, can be relative, friend or caretaker and/or an administrator who manages the system) via the recipient device in case of emergency for help when emergency event occurs. In some implementations, another set of buttons of the buttons can be configured to adjust displayed time on the display of the alarm clock module 111. The standalone device 110 can be wireless coupled to the recipient device 120 via the wireless communication module 113. In some implementations the wireless connection between the standalone device 110 and the recipient device 120 can be through Wi-Fi or cellular data service, which can be understood that the wireless communication module 113 may be, but not limited to, a Wi-Fi module, bluetooth or a sim card module depending on the connection techniques. The standalone device 110 for seniors or elderly, which may be in a form factor of alarm clock, digit watch or pendant (as described referring to FIGS. 2A to 4B), is designed to inform the device user's recipient(s) (relative, friend or caretaker) if the senior or elderly fails to deactivate the foresaid wake-up, wellness check or medicine reminder alarm set at the certain time of the day or with the interval of various preset time. In some implementations, the standalone device or the recipient device 120 can be a cellphone or tablet wirelessly coupled to each other, which operates foresaid functions with the standalone device 110 or the recipient device 120 by applications installed thereon. In some implementations, persons involved in using the standalone device 110 may be the device user, as the person who is using the standalone device 110 and is being monitored; an administrator, as the person who is managing the devices. In some implementations, the administrator of the standalone device 110 can be the device user or designed recipient (by device user, can be relative/friend/caretaker) when the device user is unable to manage the standalone device 110. In some implementations, the recipient, the designated person(s) who is receiving notifications (such as on the recipient device 120 or other designated devices) from the standalone device 110, can be relative, friend or caretaker, who monitors the device user's wellness. The recipient (relative, friend or caretaker) device according to some implementations of the present disclosure will be detailed described referring to FIG. 5 as follows.

FIGS. 2A and 2B are diagrams respectively illustrating the front view and the rear view of an example standalone device 210 in alarm clock form, according to some implementations of the present disclosure. In FIG. 2A, the standalone device 210 includes a first button 212a and a second button 212b. In this case, the first button 212a includes an indication light, which flashes when the alarm of the standalone device 210 is triggered by various events or functions. The second button 212b is configured as the mentioned emergency or SOS button. A display 211a may be included on the front panel of the standalone device 210, which can display time, settings or alarm of the standalone device 210. In FIGS. 2A and 2B, additional to the first button 212a and the second button 212b, the standalone device 210 includes time adjusting buttons 212c on the side of the standalone device 210, configured to adjust the time displayed on the display 211a, a speaker 211b for sounding the alarm. As shown in FIG. 2B, on the rear side of the standalone device 210, there is, a battery compartment 214 for powering the standalone device 210, and a SIM card slot 213 for wireless communication with a wireless coupled device, such as the recipient device 120 of FIG. 1. The standalone device 210 also includes a microphone 211c, which can be used with the speaker 211b while a speak function is activated by specific events, with the recipient device.

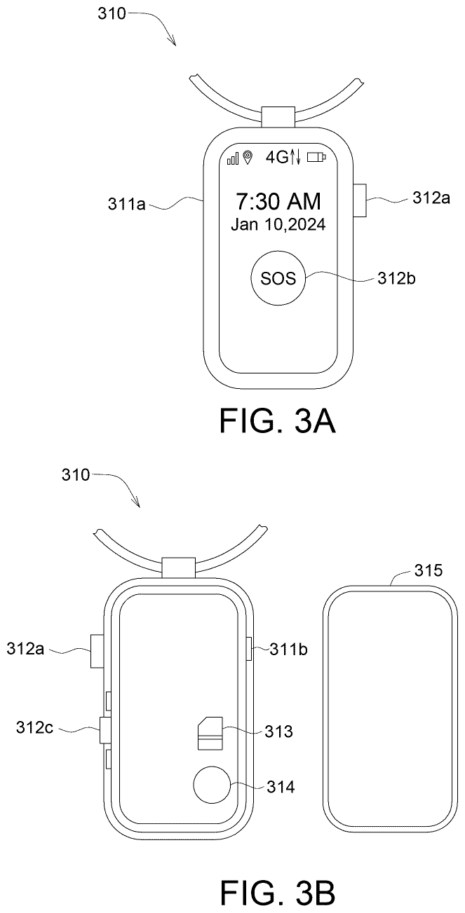

FIGS. 3A and 3B are diagrams respectively illustrating the front view and the rear view of an example standalone device 310 in pendant form, according to some implementations of the present disclosure. Similarly with the standalone device 210 of FIGS. 2A and 2B, in FIG. 3A, the standalone device 310 includes a first button 312a and a second button 312b. In this case, the first button 312a also includes an indication light, which flashes when the alarm of the standalone device 310 is triggered by various events or functions. The second button 312b is a physical button of the standalone device 310, as SOS button. The screen 311a is included on the front panel of the standalone device 310, which can also display time, or alarm settings of the standalone device 310. In FIG. 3B, additional to the first button 312a, the standalone device 310 includes time adjusting buttons 312c on the side of the standalone device 310, configured to adjust the time displayed on the touch screen 311a. As shown in FIG. 3B, on the other side or the rear side of the standalone device 310, there are a speaker 311b for sounding the alarm, a button battery 314 for powering the standalone device 310, and a SIM card holder 313 for wireless communication with a wireless coupled device, such as the recipient device 120 of FIG. 1. The standalone device 310 also includes a microphone 311c, which can be used with the speaker 311b while a speak function is activated by specific events, with the recipient device. A back cover 315 is provided to be assembled on the back of the standalone device 310, which can protect the mentioned components on the back of the standalone device 310, or be removed to replace the battery or SIM card.

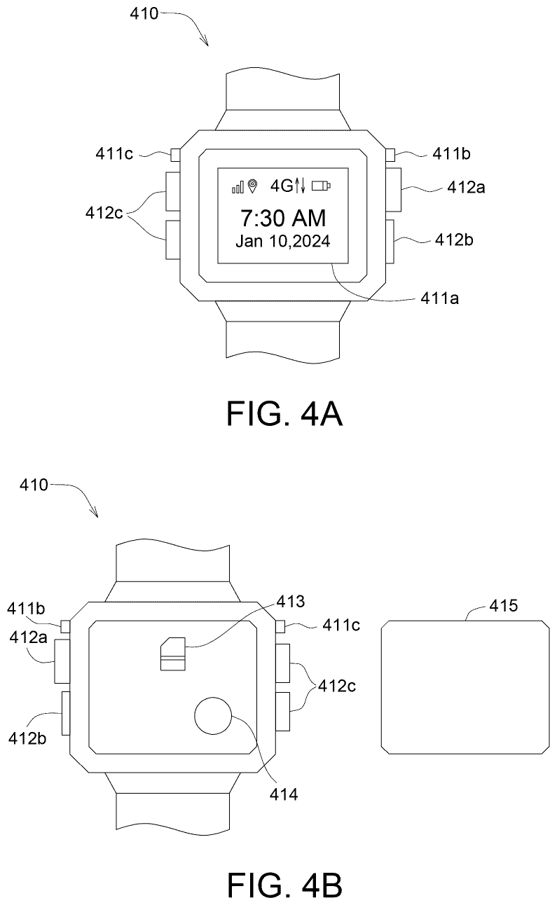

FIGS. 4A and 4B are diagrams respectively illustrating the front view and the rear view of an example standalone device 410 in digit watch form, according to some implementations of the present disclosure. Similarly with the standalone device 210, 310 of FIGS. 2A to 3B, in FIG. 4A, the standalone device 410 includes a first button 412a and a second button 412b disposed on the side of the standalone device 410. In this case, the first button 412a also includes an indication light, which flashes when the alarm of the standalone device 410 is triggered by various events or functions. The second button 412b is configured as the mentioned emergency or SOS button. Additional to the first button 412a and the second button 412b, the standalone device 410 includes time adjusting buttons 412c disposed on the opposite side of the standalone device 410, configured to adjust the time displayed on the display 411a. The display 411a is included on the front panel of the standalone device 410, which can also display time, settings or alarm of the standalone device 410. As shown in FIG. 4B, on the left side of the standalone device 410, there are a speaker 411b for sounding the alarm. On the rear side, a button battery 414 for powering the standalone device 410, and a SIM card holder 413 for wireless communication with a wireless coupled device, such as the recipient device 120 of FIG. 1. A back cover 415 is provided to be assembled on the back of the standalone device 410, which can protect the mentioned components on the back of the standalone device 410, or be removed to access the same as the pendant form factor. The standalone device 410 also includes a microphone 411c on the other side, which can be used with the speaker 411b while a speak function is activated by specific events, with the recipient device.

FIG. 5 is a diagram illustrating the App functions of an example device 520, according to some implementations of the present disclosure. The device 520 can be configured as an administrator device or a recipient device, by the application, to perform various App functions. As discussed above, the recipient device (such as the device 520 after configuring for an administrator or other recipient, such as relative, friend or caretaker) can be a cellphone or tablet wirelessly coupled to a standalone device (e.g., the standalone devices 110, 210, 310, and 410 of FIGS. 1 to 4B), which operates foresaid functions with the wireless coupled standalone device by applications installed thereon, as shown in FIG. 5. For example, an application for Apple IOS and Android OS will be developed to control and communicate with the standalone device from the administrator or recipient device (such as the device 520). A recipient (user of the recipient device) can be also set as an administrator of the standalone device (such as the device 210, 310 or 410), and client devices for multiple client users (including standalone seniors or elderly, friends, family and/or caretaker) can be connected to the standalone device (such as the device 210, 310 or 410), through the application. The Application installed on the recipient device (such as the device 520) has a user interface display on the touch screen of 521 thereof. The recipient (device user and administrator) can be established during the initial setup of the recipient device (such as device 520). In some implementations, user accounts can be established from the standalone device manufacturer's website identified by e-mail address or cellphone number and user selected password. In some implementations only device user and administrator may change the alarm clock setting, language selection, customize alert messages and authorize client users of the client device to connect to the standalone device (such as the device 210, 310 or 410). The authentication can be done by username (e-mail address or cellphone number), password and the MAC address of the standalone device. As discussed above, the connection between the standalone device and the recipient device (such as the device 520) can be through Wi-Fi or cellular data service. The initial setup for the standalone device can be done through Wi-Fi or Bluetooth connectivity between the standalone device and the administrator or recipient device (such as the device 520). In some implementations, a QR code can be generated for the standalone device to allow client users to connect to the standalone device 210, 310 or 410 by logging in manufacturer's website. For additional security, confirmation messages can be sent to the recipient by the administrator of the system to approve client user's login to the standalone device. The user information 528 including name of user (such as seniors or elderly) of the standalone device, can be displayed on the user interface of the application shown on the touch screen 521 of the administrator or recipient device (such as the device 520), which can be used to identify the user's identity, of the standalone device. A dialogue box 529 is configured to display messages, notifications or dialogues from the corresponding standalone device according to the user information 528, which the messages, notifications or dialogues can be manually entered by the coupled standalone device user or can be generated automatically corresponding to the mentioned functions or events. Following functions are respectively represented as icons 522˜527 on the user interface of the application installed on the recipient device (such as the device 520).

Icon 522 represents a phone call function in the application, which allows the recipient (relative, friend or caretaker) to call a phone (rather than the standalone device which is unavailable at the time) of the standalone device user through the cellular service, without dialing or going to recipient device's address book. Icon 523 represents a speak function of allowing the recipient to speak to the standalone device user directly through the wireless connection. Icon 524 represents a map function including a geological location to locate the standalone device. Icon 527 represents a wellness check function, which sends a wellness check notification from the recipient device (such as the device 520) to the standalone device and allows the recipient (relative, friend or caretaker) of the recipient device (such as the device 520) to check response from the standalone device user (210, 310 or 410) at any time. This feature is the same as wellness check from the standalone device and will not affect the wellness check setting on standalone devices.

Icon 526 represents a reset function configured to clear message sent from the standalone device shown in the dialogue box 529 or stop the conversation with the standalone device user. Icon 525 represents a setting function configured to adjust settings for the administrator or recipient device and the installed application.

The recipient device (such as the device 520) can further includes an automatic self-diagnostic function, which automatically sends a diagnostic signal (or ping) to the standalone device in a preset time interval (such as every two hours or other specific time interval), to assure that the standalone device is functioning properly and is connected to the recipient device. The user interface on the recipient device (such as the device 520) will issue an alert message in the dialogue box 529 if the standalone device fails to respond to the diagnostic signal (or ping). The recipient can contact the standalone device user to check the standalone device assuring that it operates properly and is connected to the recipient device (such as the device 520). Any issue related to internet connection, power failure or device malfunction may be fixed in a timely manner.

As discussed above, the recipient device (such as the device 520 after configuring as a recipient device) can be a cellphone or tablet wirelessly coupled to a standalone device, which operates foresaid functions with wireless connection by applications installed thereon, as shown in FIG. 5. In this case, the App functions for the recipient device (such as the device 520) may further include a function (icon 530) of disabling alarm or skipping next alarm (only available to the device user and administrator), and a function of sending SOS signal (icon 531) to client users (only available to the device user and administrator). These two functions (530 and 531) are meant to be used only by the device user and administrator. If the standalone device user is the administrator, he/she can disable the alarm or send SOS notification if he/she is away from the standalone device. For example, if he/she is not in the bedroom to press the button on the alarm clock, he/she can do so from the App on his/her coupled recipient device (cellphone or tablet).

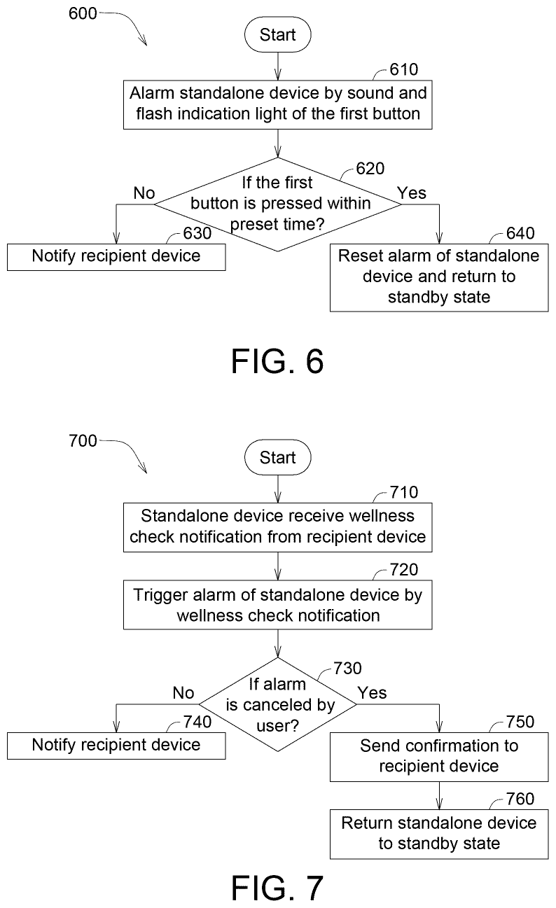

FIG. 6 is a flow chart of an example method (Disable alarm process) 600 for a standalone device wirelessly communicating with a recipient device, according to some implementations of the present disclosure. As discussed above, the alarm of the standalone device can be set at wake-up time, medicine reminder time and multiple wellness monitoring time (such as by the alarm clock module 111 and the input module 112 of the standalone device 110 in FIG. 1). In some implementations, the wake-up alarm, medicine reminder alarm, wellness monitoring time can be only set or adjusted by the administrator device, which the alarms cannot be modified by the recipients of the standalone device. In some implementations, the wake-up time (alarm) will be once a day, the interval of medicine reminder time (alarm) can be 4 hours or 8 hours, or other specific time, and the interval of multiple wellness monitoring time (alarm) can be 6 hours or 12 hours, or other specific time. The alarm of standalone device will be indicated by sound such as by the speaker 211b, 311b or 411b in FIG. 2, 3 or 4, and flashing red on the first button 212a, 312a, or 412a in FIG. 2, 3 or 4, respectively (step 610). In some implementations, the alarm of the standalone device sounds for 5 minutes (or second preset time) at the alarm time and the first button will flash in color (such as red or orange). If the user presses the first button within the second preset time (such as 5 minutes) (step 620), the alarm of the standalone device resets and the standalone device returns to standby state (step 640). If the user does not press the first button within the second preset time (such as 5 minutes) (step 620), the recipient device is notified (step 630), which the recipient (relative, friend or caretaker) may use the speak function from the application (such as icon 523 of FIG. 5) to call the device user's standalone device to check his or her wellness and provide necessary help. The recipient may use the call function 522 from the App to call the device user's phone. Multiple alarms can be set throughout the day to monitor the wellness of the standalone device user as well as a medicine reminder. In some implementations, the alarm of the standalone device can also be set by the coupled administrator (can be device user) device. In case the user fails to cancel the wake-up alarm, the recipient device will receive a message, for example, “Alert! John Doe fails to disable the wake-up alarm. Please contact him to ensure his wellness”, such message will be shown in the dialogue box 529 in FIG. 5. In case the user fails to cancel the medicine reminder alarm, the recipient device will receive a message, for example, “Alert! John Doe fails to confirm medicine reminder”, such message will be shown in the dialogue box 529 in FIG. 5.

FIG. 7 is a flow chart of an example method (wellness check notification process) 700 for a standalone device wirelessly communicating with a recipient device, according to some implementations of the present disclosure. As discussed above, wellness check function allows the recipient (relative, friend or caretaker) to check the wellness of the standalone device user at any time. When the recipient clicks the wellness check icon from the application installed on the recipient device (such as icon 527 of FIG. 5), the coupled standalone device receives a wellness check notification from the recipient device (step 710). The alarm of standalone device is then triggered by the wellness check notification (step 720). In some implementations, the alarm on the standalone device will sound (such as by the speaker 211b, 311b or 411b in FIG. 2, 3 or 4, respectively) and the first button with an indication light (such as the first button 212a, 312a, or 412a in FIG. 2, 3 or 4, respectively) flashes in orange color, for a preset time, such as 5 minutes or other specific time interval. If alarm is canceled by pressing the first button within the preset time by the standalone device user (step 730), a confirmation is sent to the application of the recipient device (step 750), to confirm the standalone device user has answered the wellness check. The recipient device may receive a message, for example, “Alert! John Doe confirmed wellness check notification”, such as the message will be shown on the dialogue box 529 of FIG. 5. Then, the standalone device returns to standby mode (step 760). If the standalone device user fails to cancel the alarm after the preset time, the recipient device is notified (step 740). The recipient device may receive a message, for example, “Alert! John Doe fails to respond to wellness check notification. Contact him immediately”, such as the message will be shown in dialogue box 529 of FIG. 5. The recipient (relative, friend or caretaker) may use the speak function from the application (such as icon 523 of FIG. 5) to call the standalone device user to check his or her wellness. The recipient may use call function (522) to call device user's phone.

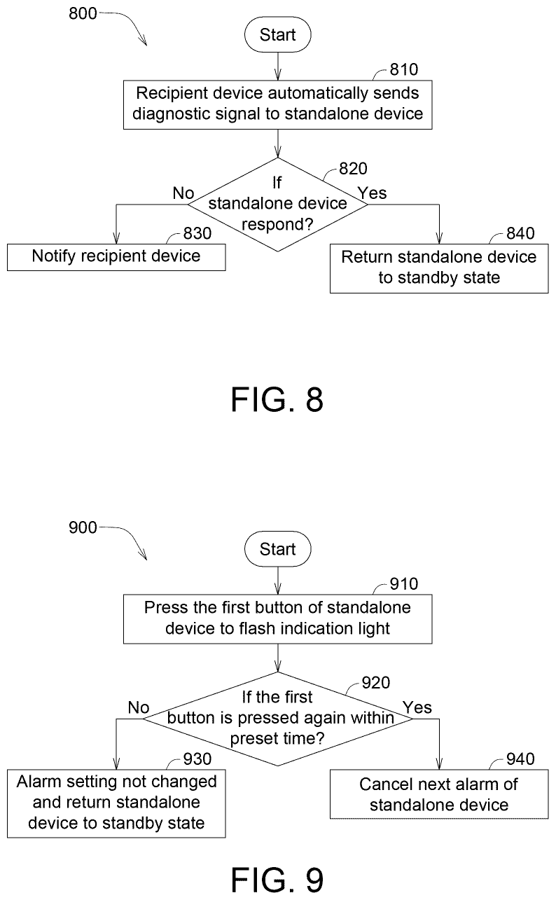

FIG. 8 is a flow chart of another example method (Automatic Diagnostic process) 800 for a standalone device wirelessly communicating with a recipient device, according to some implementations of the present disclosure. As discussed above, the application installed on the recipient device sends diagnostic signal (or ping) to the standalone device in a preset time interval (such as every two hours or other specific time interval), to assure that the standalone device is functioning properly and is connected to the recipient device (step 810) and determines that if the standalone device responds (step 820). If the standalone device responds properly, the standalone device returns to standby mode (step 840). If the standalone device fails to respond to the diagnostic signal (or ping), the recipient device is notified (step 830). The recipient device may receive a message, for example, “Alert! John Doe's device fails diagnostic check. Contact him/her immediately to resolve the problem”, such message will be show in the dialogue box 529 of FIG. 5.

The recipient may use the call function 522 from the App to call the device user's phone. Any problem related to Internet connection, power failure or device malfunction of the standalone device may be fixed in a time manner.

FIG. 9 is a disable/confirmation flowchart of an example method (Cancel Next Alarm process) 900 for a standalone device skipping the next alarm, according to some implementations of the present disclosure. The preset alarm (or the next alarm) of the standalone device may be skipped by the standalone device user if necessary. To initiate the operation, the user presses the first button with an indication light (such as the first button 212a, 312a, or 412a in FIG. 2, 3 or 4, respectively) flashes (step 910). In some implementations, during the alarm, the first button flashes in color, such as red or orange, for a preset time, such as one minute, and the alarm will be sounded by the speaker of the standalone device (such as the speaker 211b, 311b or 411b in FIG. 2, 3 or 4, respectively). If the first button is pressed again within the preset time by the user (S920), the next alarm of the standalone device is canceled (or skipped) and standalone device returns to standby state (S940). If the first button is not pressed again within the preset time by the user (S920), the alarm setting of the standalone device is not changed and the standalone device returns to the standby state (S930).

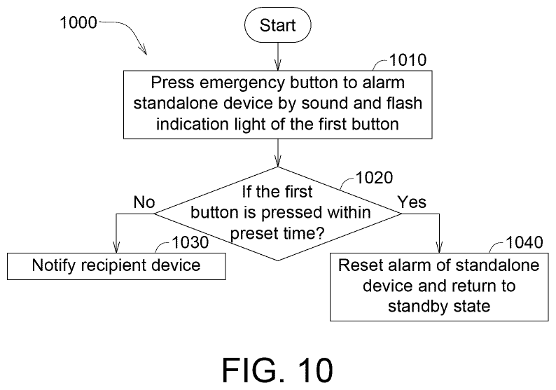

FIG. 10 is a flow chart of an example method (Emergency Notification) 1000 for a standalone device for sending emergence (SOS) signal, according to some implementations of the present disclosure. In case the standalone device user needs to call for help, the standalone device user may press the emergency (SOS) button (such as the second button 212b, 312b, or 412b in FIG. 2, 3 or 4, respectively). Once the emergency (SOS) button is pressed by the standalone device user, the alarm of standalone device will be indicated by sound such as by the speaker 211b, 311b or 411b in FIG. 2, 3 or 4, and flashing red on the first button 212a, 312a, or 412a in FIG. 2, 3 or 4, respectively. In some implementations, the alarm of the standalone device sounds for 5 minutes (or second preset time) at the alarm time and the first button will flash in color (such as red or orange) (step 1010). If the user presses the first button within the preset time (step 1020), the alarm of the standalone device resets and the standalone device returns to standby state (step 1040). If the user does not press the first button within the preset time (step 1020), the recipient device is notified (step 1030), which the recipient (relative, friend or caretaker) may use the speak function from the application (such as icon 523 of FIG. 5) to call the device user's standalone device to check his or her wellness and provide necessary help. The recipient may also use the call function 522 from the App to call the device user's phone. In case the standalone device sends emergence (SOS) signal, the recipient device will receive a message, for example, “Alert! John Doe sends help notification. Please contact him to provide assistance”, such message will be shown in the dialogue box 529 in FIG. 5.

By the techniques provided by the implementations according to the present disclosure discussed above, the recipient (relative, friend or caretaker) will be informed by the recipient device in any event from the standalone device without requiring any monitoring services.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalent to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for a standalone device wirelessly communicating with a recipient device, comprising:
setting, by an administrator, a wake-up alarm of the standalone device with a first preset time;
triggering the wake-up alarm of the standalone device by the first preset time, wherein the wake-up alarm enables to flash an indication light of a first button of the standalone device; and
informing, by the standalone device, the recipient device if the wake-up alarm of the standalone device is not canceled by pressing the first button by a user within a second preset time.

2. The method of claim 1, wherein upon determining that the wake-up alarm of the standalone device is not canceled within the second preset time, the standalone device sends a notification to the recipient device.

3. The method of claim 1, further comprising:
sending a diagnostic signal, by the recipient device, automatically, to the standalone device with an interval of a third preset time; and
generating an alert message on the recipient device, upon determining that the standalone device fails to response the diagnostic signal.

4. The method of claim 1, further comprising:
receiving, by the standalone device, a wellness check notification from the recipient device;
triggering a wellness check alarm of the standalone device by the wellness check notification of the standalone device by the wellness check notification, wherein the wellness check alarm enables to flash the indication light of the first button of the standalone device; and
informing, by the standalone device, the recipient device whether the wellness check alarm of the standalone device is canceled by pressing the first button by the user within the second preset time.

5. The method of claim 1, wherein the wake-up alarm of the standalone device is adjustable by the administrator via the recipient device.

6. The method of claim 1, further comprising:
setting, by the administrator, a medicine reminder alarm of the standalone device with an interval of a fourth preset time;
triggering the medicine reminder alarm of the standalone device by the interval of the fourth preset time, wherein the medicine reminder alarm enables to flash the indication light of the first button of the standalone device; and
informing, by the standalone device, the recipient device if the medicine reminder alarm of the standalone device is not canceled by pressing the first button by the user within the second preset time.

7. The method of claim 6, wherein a next alarm due to the first preset time or the interval of the fourth preset time is skippable by pressing the first button to flash the indication light without the wake-up alarm or the medicine reminder alarm, and pressing the first button again while the indication light flashing, by the user.

8. A wireless communication system, comprising:
a standalone device, comprising an alarm and a first button including an indication light; and
a recipient device, wirelessly coupled to the standalone device,
wherein by a first preset time of a wake-up alarm set by an administrator, the alarm of the standalone device is triggered to flash the indication light of the first button of the standalone device and to sound, and the standalone device informs the recipient device if the alarm of the standalone device is not canceled by pressing the first button by a user within a second preset time.

9. The system of claim 8, wherein the recipient device automatically sends a diagnostic signal to the standalone device with an interval of a third preset time, and the recipient device receives an alert message upon determining that the standalone device fails to response the diagnostic signal.

10. The system of claim 8, wherein upon determining that the standalone device receives a wellness check notification from the recipient device, the alarm of the standalone device is triggered to flash the indication light of the first button of the standalone device, and the standalone device informs the recipient device whether the alarm of the standalone device is canceled by pressing the first button by a user within the second preset time.

11. The system of claim 10, wherein the first preset time of the wake-up alarm of the standalone device is adjustable by the administrator via the recipient device.

12. The system of claim 11, wherein by an interval of a fourth preset time of a medicine reminder alarm set by the administrator, the alarm of the standalone device is triggered to flash the indication light of the first button of the standalone device, and the standalone device informs the recipient device if the alarm of the standalone device is not canceled by pressing the first button by the user within the second preset time.

13. The system of claim 12, wherein a next alarm due to the first preset time or the interval of the fourth preset time is skippable by pressing the first button to flash the indication light without the wake-up alarm or the medicine reminder alarm and pressing the first button again while the indication light flashing, by the user.

14. A standalone device, comprising:
a wireless communication module;
an alarm clock module; and
a first button, including an indication light,
wherein by a first preset time of a wake-up alarm set by an administrator, the alarm of the standalone device is triggered to flash the indication light of the first button of the standalone device, and the standalone device informs a wirelessly coupled recipient device via the wireless communication module if the alarm of the standalone device is not canceled by pressing the first button by a user within a second preset time.

15. The standalone device of claim 14, wherein upon determining that the wake-up alarm of the standalone device is not canceled within the second preset time, the standalone device sends a notification to the recipient device.

16. The standalone device of claim 14, wherein the standalone device receives a diagnostic signal automatically sent by the wirelessly coupled recipient device with an interval of a third preset time, and the wirelessly coupled recipient device receives an alert message upon determining that the standalone device fails to response the diagnostic signal.

17. The standalone device of claim 14, wherein upon determining that the standalone device receives a wellness check notification from the recipient device, the alarm of the standalone device is triggered to flash the indication light of the first button of the standalone device, and the standalone device informs the wirelessly coupled recipient device via the wireless communication module if the alarm of the standalone device is not canceled by pressing the first button by the user within the second preset time.

18. The standalone device of claim 17, the first preset time of the wake-up alarm of the standalone device is adjustable by the administrator via the wirelessly coupled device.

19. The standalone device of claim 17, wherein a next alarm due to the first preset time is skippable by pressing the first button to flash the indication light without the wake-up alarm, and pressing the first button again while the indication light flashing, by the user.

20. The standalone device of claim 14, further comprising a second button configured to send emergence signal,
wherein when the second button is pressed by the user for emergency, the alarm of the standalone device is triggered to flash the indication light of the first button of the standalone device,
wherein the standalone device informs the wirelessly coupled recipient device via the wireless communication module upon determining that the alarm of the standalone device is not canceled by pressing the first button by the user within a second preset time,
wherein the alarm of the standalone device is reset and returned to a standby state upon determining that the alarm of the standalone device is canceled by pressing the first button by the user within the second preset time.
